(19) United States
(12) Patent Application Publication
(10) Pub. No.: US 2015/0113244 A1
(43) Pub. Date: Apr. 23, 2015

(54) CONCURRENTLY ACCESSING MEMORY

(71) Applicant: Alibaba Group Holding Limited, Grand Cayman (KY)

(72) Inventors: Ling Ma, Hangzhou (CN); Sihai Yao, Hangzhou (CN); Lei Zhang, Hangzhou (CN)

(21) Appl. No.: 14/515,952

(22) Filed: Oct. 16, 2014

(30) Foreign Application Priority Data
Oct. 18, 2013 (CN) 201310492402.3

(51) Int. Cl. G06F 13/16; G06F 9/46

(52) U.S. Cl. CPC G06F 13/1615; G06F 9/467
USPC 711/168

(57) ABSTRACT

When a first transaction needs to conduct a writing operation to first data, after there is a determination that there exists a second transaction that has conducted a reading operation of the first data or is to conduct a reading operation of the first data, a record that indicates a conflict between the writing operation of the first transaction and the reading operation of the second transaction is generated. A processing of the second transaction is performed. After the processing is completed, the second transaction is submitted and the first transaction is notified according to the record. A processing of the first transaction is performed. After the processing is completed and a notification of the second transaction is received, the first transaction is submitted. The present techniques improve concurrently visiting transaction memory at a multi-core system, avoid rollbacks incurred by conflicts, and improve overall system performance.

### CROSS REFERENCE TO RELATED PATENT APPLICATIONS

This application claims foreign priority to Chinese Patent Application No. 201310492402.3 filed on 18 Oct. 2013, entitled “Method and Device for Concurrently Accessing Memory,” which is hereby incorporated by reference in its entirety.

### TECHNICAL FIELD

The present disclosure relates to computer technology and, more particularly, to a method and device for concurrently accessing memory.

### BACKGROUND

In recent years, computers have been developed with the architecture of multiple cores as processor manufacturers are trying to maintain a continuous growth of high performance computation when restricted by power consumption and temperature. To fully utilize the architecture of multiple cores, an application program is divided into a plurality of threads, each of which may be independently executed at a single central processing unit (CPU). Thus, the application program may be executed in parallel to enhance a whole operating efficiency. A system based on such a procedure scheme needs to ensure data concurrency and data integrity in the data processing so that a certain kind of concurrent mechanism is needed for serially accessing a shared area among the threads.

Transaction memory is introduced to improve a degree of parallel operation of threads. The transaction memory assumes that there are rare conflicts of write-read, read-write, and write-write among the threads of the multiple cores when accessing the shared data and thus the multiple threads are allowed to be tentatively executed in parallel. When there is any conflict found, a rollback operation is performed to restore the application program to a state prior to the conflict. Accordingly, the performance and expandability of the system is improved while the data integrity is not affected.

The scheme of transaction memory is widely used in a parallel system to enhance the expandability of the system architecture. The transaction memory technology has been embedded into the architecture of CPU including IBM™'s Blue Gene/Q and Intel™'s Haswell.

Although the scheme of transaction memory improves the degree of parallel operation of the threads, with the improvement of the degree of the parallel operation, the probability of conflict is also increased. If the rollback operation is performed once there is a conflict, the performance of the program would be seriously hurt.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to apparatus(s), system(s), method(s) and/or computer-readable instructions as permitted by the context above and throughout the present disclosure.

The technical problem to be solved by the present disclosure is to improve concurrency for accessing a transaction memory in a system of multiple cores and to reduce a rollback operation for conflicts, thereby improving an overall system performance.

The present disclosure provides an example method for concurrently accessing a memory.

When a first transaction needs to conduct a writing operation to first data, after there is a determination that there exists a second transaction that has conducted a reading operation of (or has read) the first data or is to conduct a reading operation of the first data, a record that indicates a conflict between the writing operation of the first transaction and the reading operation of the second transaction is generated.

A processing of the second transaction is performed. After the processing is completed, the second transaction is submitted and the first transaction is notified according to the record. A processing of the first transaction is performed. After the processing is completed and a notification of the second transaction is received, the first transaction is submitted.

For example, the step of generating the record which indicates the conflict between the writing operation of the first transaction and the reading operation of the second transaction may include the following operations.

At a first reading and writing conflict detection register of a first processor which operates the first transaction, a processor flag bit corresponding to a second processor which operates the second transaction is set and an operation conflict flag bit is set as a value indicating an occurrence of the writing operation conflict.

At a second reading and writing conflict detection register of the second processor, a processor flag bit corresponding to the first processor is set and an operation conflict flag bit is set as a value indicating an occurrence of the reading operation conflict.

For example, the step of notifying the first transaction according to the record may include the following operations.

At the second reading and writing conflict detection register, the processor flag bit that has been set is searched. The processor flag bit that has been set is determined as corresponding to the first processor. The first transaction which is operated at the first processor is notified.

For example, the step of performing the process of the first transaction and, after said process is completed and the notification of the second transaction is received, submitting the first transaction may include the following operations.

At a step A, the processing of the first transaction is performed. After the processing is completed, operations at a step B are performed.

At the step B, the operation conflict flag bit at the first reading and writing conflict detection register is determined whether represented by the value indicating the occurrence of the writing operation conflict. Operations at a step C are performed if a result is positive. Operations at a step E are performed if the operation conflict flag bit is represented by a value indicating the occurrence of the reading operation conflict.

At the step C, it is determined whether none of the processor flag bits at the first reading and writing conflict detection register is set. The operations come to a standby state when at least one of the processor flag bits has been set. Operations at the step E are performed when none of the processor flag bits is set.

At a step D, after the notification of the second transaction is received, at the first reading and writing conflict detection register, the processor flag bit corresponding to the second processor is reset. The operations return to the step C.

At the step E, the first transaction is submitted.

For example, after the step of determining whether the second transaction that has read the first data or is to read the first data exists, the example method may further include the following operations.

If the second transaction has conducted the reading operation of the first data, prior to the processing of the first transaction, a cache line of the first data corresponding to the second transaction is copied to a private invisible cache corresponding to the first transaction.

If the second transaction is to conduct the reading operation of the first data, prior to the processing of the second transaction, from a cache line corresponding to the first transaction, the first data to which the writing operation has not been conducted is copied to a cache corresponding to the second transaction.

The present disclosure also provides an example device for concurrently accessing memory. The device may include a cache managing unit, a first processing unit, and a second processing unit.

The cache managing unit, when a first transaction needs to conduct a writing operation to first data, if there exists a second transaction that conducts a reading operation of the first data or is to conduct a reading operation of the first data, generates a record that indicates a conflict between the writing operation of the first transaction and the reading operation of the second transaction.

The first processing unit performs a processing of the first transaction and, after the processing is completed and a notification of the second transaction is received, submits the first transaction.

The second processing unit performs a processing of the second transaction and, after the process is completed, submits the second transaction and notifies the first transaction according to the record.

Alternatively, the device may also include a first reading and writing conflict detection register corresponding to the first processing unit and a second reading and writing conflict detection register corresponding to the second processing unit.

Alternatively, the process that the cache managing unit generates the record indicating the conflict between the writing operation of the first transaction and the reading operation of the second transaction may include the following operations. The cache managing unit, at the first reading and writing conflict detection register, sets a processor flag bit corresponding to the second processing unit and sets an operation conflict flag bit as a value indicating an occurrence of a writing operation conflict. The cache managing unit, at the second reading and writing conflict detection register, sets a processor flag bit corresponding to the first processing unit and sets the operation conflict flag bit as a value indicating an occurrence of a reading operation conflict.

Alternatively, the process of the second processing unit notifying the first transaction according to the record may include the following operations. The second processing unit, at the second reading and writing conflict detection register, searches the processor flag bit that has been set, determines that the processor flag bit that has been set is corresponding to the first processing unit, and notifies the first transaction that is operated on the first processing unit.

Alternatively, the first processing unit may include a first determining module, a second determining module, a performing module, and a cleaning module. The performing module performs the process of the first transaction and, after the process is completed, instructing the first determining module to perform an operation of determination.

The clearing module, after the notification of the second transaction is received, at the first reading and writing conflict detection register, resets the processor flag bit corresponding to the second processing unit and instructs the second determining module to perform an operation of determination.

The first determining module determines whether the operation conflict flag bit in the first reading and writing conflict detection register is the value indicating the occurrence of the writing operation conflict. If a determination result is positive, the first determining module instructs the second determining module for determination. If the value indicates the occurrence of the reading operation conflict, the first determining module instructs a submitting module to submit the first transaction.

The second determining module determines whether none of the processor flag bits at the first reading and writing conflict detection register is set. If a determination result is positive, the second determining module instructs the submitting module to submit the first transaction.

Alternatively, the cache managing unit, when it is determined that the reading operation of the first data has been occurred at the second transaction, before the first processing unit performs the first transaction, copies a cache line of the first data corresponding to the second transaction to a private invisible cache corresponding to the first transaction.

If the cache managing unit determines that the reading operation of the first data is to be occurred in the second transaction, before the second processing unit performs the processing of the second transaction, from a cache line corresponding to the first transaction, copies the first data to which the writing operation has not been conducted to a cache corresponding to the second transaction.

The present techniques enable other cores to read the same data concurrently while one thread is writing data. The present techniques improve the parallel reading operation for multiple cores and avoid the time for roll backing the transaction memory due to a reading and writing operation conflict and a write-reading operation conflict based on the precondition of maintaining data integrity. Eventually, the present techniques improve the concurrency and the throughput of the system, thereby improving an overall performance and an expandability of the multiple cores system. In another example embodiment of the present disclosure, a transaction conflict register is provided for effectively recording an object and a type of the conflict, and a submitting sequence of the transactions is ensured by the transaction conflict register. However, it is noted that any product implemented by the present disclosure is not necessary to have all advantages as described above.

### BRIEF DESCRIPTION OF THE DRAWINGS

FIG. 1 is a flowchart illustrating an example method for concurrently accessing a memory according to a first example embodiment of the present disclosure.

FIG. 2 is a schematic diagram illustrating an example reading and writing operation conflict register according to the first example embodiment of the present disclosure;

FIG. 3 is a flowchart illustrating an example step 106 in FIG. 1 according to the first example embodiment of the present disclosure.

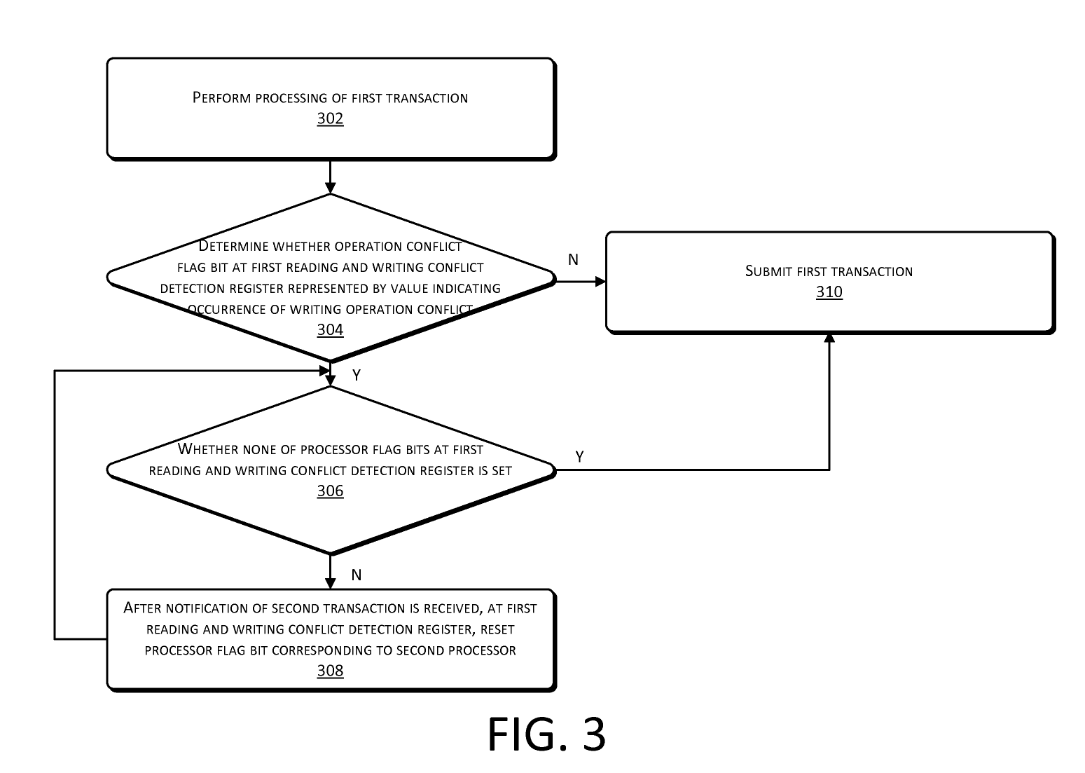

FIG. 4 is a schematic flow chart illustrating a first example in the first embodiment of the present disclosure.

FIG. 5 is a schematic flow chart illustrating a second example in the first embodiment of the present disclosure.

FIG. 6 is a diagram illustrating an example device of the present disclosure.

### DETAILED DESCRIPTION

The details of the present disclosure will be explained in detail by referring to the accompanied FIGs and example embodiments.

It is noted that the embodiments of the present disclosure and the features thereof may be combined and such combination shall be still within the scope of the present disclosure. Further, although a logical sequence has been shown in the flow charts or FIGs, in some circumstances, some sequences different from those shown may be performed.

In a typical configuration, a multiple cores system may include a plurality of central processing units (CPUs), one or more input/output interfaces, network interfaces and memory.

The memory may be a computer-readable medium in one or more forms including a volatile memory, a random access memory (RAM), and/or a nonvolatile memory, such as a read only memory (ROM) or a flash memory (flash RAM). The memory is an illustrative example of the computer-readable medium.

The computer-readable medium includes permanent, non-permanent, movable, and non-movable medium that may achieve a goal of information storage by any methods or schemes. Information may be computer-readable instructions, data structures, process modules, or any other data. Examples of the computer-readable medium may include, but are not limited to, a phase-change random access memory (PRAM), a static random access memory (SRAM), a dynamic random access memory (DRAM), any other types of random access memory (RAM), a read only memory (ROM), an electrically erasable programmable read only memory (EEPROM), a flash memory or memory with any other technology, a compact disc read-only memory (CD-ROM), digital versatile disc (DVD) or other optical storage, magnetic cassettes, a magnetic disk storage or other magnetic tape magnetic storage devices, or any other non-transmission medium that can be used for storing the information accessible by a computing device. According to the definition of the present disclosure, the computer-readable media does not include transitory media such as a modulated data signal and carrier.

After nearly 20 years of development, a transaction memory may be implemented by either software or hardware. The software implementation of the transaction memory has a very low efficiency, and the hardware implementation of the transaction memory greatly improves its utilization. Therefore the present disclosure mainly focuses on the hardware-based transaction memory.

Firstly, a working principle of the hardware-based transaction memory is described below. The transaction memory uses codes to inform the CPU of a beginning and an end of the transaction memory area, such as “Transaction_{—} tart” and “Transaction_end.” An area which executes the transaction is a middle section between the codes of “Transaction_start” and “Transaction_end.” Once the execution ends, the instruction of “Transaction_end” will request the CPU to submit all modified data in a modular form (in other words, the submitting process may not be interrupted or visited).

During a transaction process, any memory area which has been read or written will be monitored to prevent a write-reading operation conflict, a reading and writing operation conflict, and a write-writing operation conflict. For example, each cache line is provided with two bits including a write-bit and a read-bit which individually represents the occurrence of a writing operation and a reading operation. For example, when a reading operation of data A has occurred in a first transaction, i.e., Transaction₀, a read-bit of a cache line corresponding to the data A is set to 1 for indicating the occurrence of reading operation. (The occurrence of the reading operation means that a reading operation has occurred in a cache corresponding to the Transaction₀ but the Transaction₀ has not yet been submitted, and the read bit is reset, i.e., set to 0, after the Transaction₀ is submitted.) If thereafter the Transaction₀ writes the data A again, data of the cache line corresponding to the data A is copied to a private invisible cache area, such as a first-level cache, to perform an updating operation. At the meantime, the write-bit and the read-bit of the cache line corresponding to the original data A are set to “1” and to “0” respectively.

When a first thread P₀ uses CPU₀ to enter an area of the first transaction Transaction₀ to write or read data of a cache line (such as 64 bytes), a corresponding write bit or read bit of the cache line will be set. On the other hand, when a second thread P₁ uses CPU₁ to enter an area of the first transaction Transaction₀ or any other transaction to be ready to read or write the same cache line that was previously written or read, such operation event will be captured by the first processor CPU₀. Accordingly a rollback operation of the first thread P₀ or the second thread P₁ will be executed as a result. Furthermore, the rollback operation also occurs in a write-writing operation conflict, which will lower the performance of CPU, especially when there are frequent operations that read or write the share memory (one or more cache lines). In other words, the concurrent operations cannot be performed and the redundant rollback operations occur, thereby seriously lowering performance.

In a data conflict, in order to rollback to an initial state where the transaction area is entered, the original data will be copied prior to a writing operation to any memory in the present transaction memory. For example, a cache line, in which a writing operation is to be conducted, a writing operation may be copied to a private invisible cache, e.g., the first-level cache. The writing operation performs a writing and updating to the cache line in the private invisible cache. As a result, once a conflict occurs, the updated data (in a unit of the cache line) in the private invisible cache, e.g., the first-level cache, is abandoned, and the procedure will be re-operated from an entry point of the transaction. If the transaction is successfully completed, the latest updated written data in the private invisible cache, e.g., the first-level cache, will replace the original data.

A first example embodiment is described below. The present disclosure provides an example method for concurrently accessing a memory.

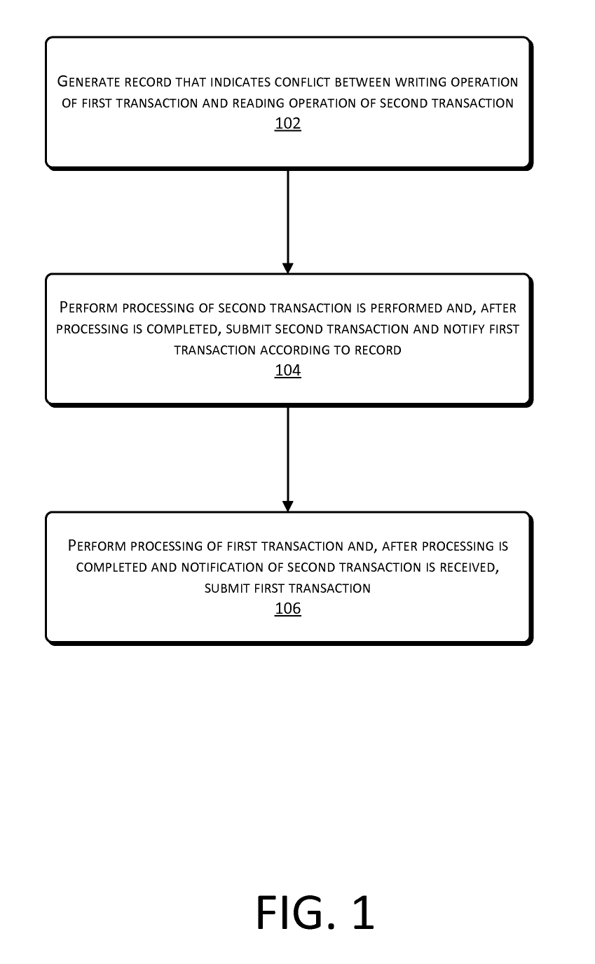

As shown in FIG. 1, at 102, when a first transaction needs to conduct a writing operation to first data, if there exists a second transaction that has conducted a reading operation of the first data or is to conduct a reading operation of the first data, a record that indicates a conflict between the writing operation of the first transaction and the reading operation of the second transaction is generated.

At 104, a processing of the second transaction is performed. After the processing is completed, the second transaction is submitted and the first transaction is notified according to the record.

At 106, a processing of the first transaction is performed. After the processing is completed and a notification of the second transaction is received, the first transaction is submitted.

The steps for performing the processes of the first transaction and the second transaction may occur without any particular sequence and may occur in parallel. The term that “the second transaction has conducted a reading operation” refers to that the data has been read in a cache corresponding to the second transaction but has been not submitted.

The present techniques implement a submission sequence and guarantee a completion of the submission sequence when a conflict occurs. The present techniques ensure the transactions are submitted according to the sequence of reading operation and writing operation to avoid the rollback operations in an event of a reading and writing operation conflict where the data, to which the reading operation is to be applied, has been read and in an event of a write-reading operation conflict where the data, to which the writing operation is to be applied, is to be read. Therefore, the present techniques improve a concurrency of reading operations and reduce an occurrence of rollback operation, thereby improving an overall performance of multi-core system.

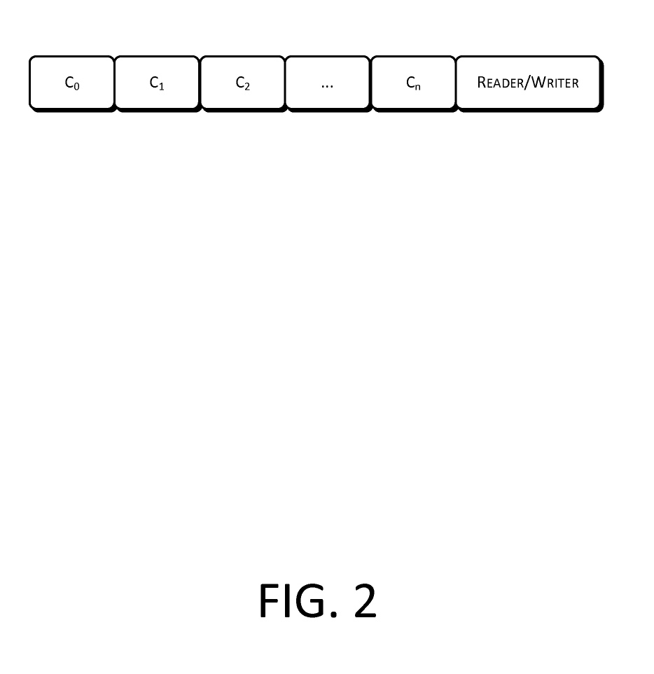

In an example embodiment of the present disclosure, each processor in a multi-core system may be additionally provided with a reading and writing conflict detection register (hereinafter referred to as a T-CCR) whose format is shown in FIG. 2. The example format in FIG. 2 includes processor flag bits C₀, C₁ . . . Cₙ corresponding to each processor in the multi-core system respectively and an operation conflict flag bit Reader/Writer that indicates the occurrence of the reading operation conflict or the writing operation conflict in the present transaction that is running on the processor. In a single transaction, it is not allowed to have the reading operation conflict and the writing operation conflict occur at the same time. If they happen at the same time, the rollback operation is required.

In the example embodiment, the step of generating the record which indicates the conflict between the writing operation of the first transaction and the reading operation of the second transaction may include the following operations.

At a first reading and writing conflict detection register of a first processor which operates the first transaction, a processor flag bit corresponding to a second processor which operates the second transaction is set and an operation conflict flag bit is set as a value indicating an occurrence of a writing operation conflict.

At a second reading and writing conflict detection register of the second processor, a processor flag bit corresponding to the first processor is set and an operation conflict flag bit is set as a value indicating an occurrence of a reading operation conflict.

For example, the step of notifying the first transaction according to the record may include the following operations.

At the second reading and writing conflict detection register, the processor flag bit that has been set is searched. The processor flag bit that has been set is determined as corresponding to the first processor. The first transaction which is operated at the first processor is notified.

For example, when there occurs a reading and writing conflict (such as a conflict between a cache line to which a Transaction₀ operated at a first processor CPU₀ is to write and a cache line which has been read by a Transaction₁ operated at a second CPU₁), at the T-CCR₀ of the first processor CPU₀, a processor flag bit C₁ corresponding to the second processor CPU₁ is set. In the meantime, a corresponding Reader/Writer is set to “1” that indicates the occurrence of writing operation conflict for the present operating Transcation₀ on the first processor CPU₀. Furthermore, at the T-CCR₁ of the second processor CPU₁, a processor flag bit C₀ corresponding to the first processor CPU₀ is reset. At the meantime, a corresponding Reader/Writer is set to “0” that indicates the occurrence of reading operation conflict for the present operating Transcation₁ on the second processor CPU₁. The values for indicating reading/writing operation conflicts are interchangeable.

With regard to the second transaction which performs the reading operation (the Reader/Writer T-CCR₁ of the second processor executing the second transaction is set to “0” and none of the processor flag bits in C₀˜Cₙ corresponding to other processors is set), even if a rollback occurs due to certain circumstances, according to a corresponding conflict bit at the T-CCR₁ of the second processor (i.e., the set processor flag bit in C₀˜Cₙ that corresponds to another processor, which is C₀ in this example), at a T-CCR of the processor corresponding to the conflict bit, a processor flag bit corresponding to the second processor (i.e., the processor flag bit C₁ in T-CCR₀ in this example) is cleared.

For example, the step of 106 may include the following operations.

At 302, the processing of the first transaction is performed. After the processing is completed, operations at 304 are performed.

At 304, the operation conflict flag bit at the first reading and writing conflict detection register is determined whether represented by the value indicating the occurrence of the writing operation conflict. Operations at 306 are performed if a result is positive. Operations at 310 are performed if the operation conflict flag bit is represented by the value indicating the occurrence of the reading operation conflict.

At 306, it is determined whether none of the processor flag bits at the first reading and writing conflict detection register is set. The operations come to a standby state when at least one of the processor flag bits has been set. Operations at 310 are performed when none of the processor flag bits is set.

At 308, after the notification of the second transaction is received, at the first reading and writing conflict detection register, the processor flag bit corresponding to the second processor is reset. The operations return to 306.

At 310, the first transaction is submitted.

For example, there may be one or more second transactions. For instance, there are two second transactions that have conducted reading operations of (or have read) the first data or are to conduct reading operations of the first data. Alternatively, one transaction has conducted reading operations of the first data and another transaction is to conduct the reading operation of the first data. In this situation, a corresponding processor flag bit in the first reading and writing operation conflict register is set. The Reader/Writer is set as a value indicating a writing operation conflict. After all the transactions which have read the first data or are to read the first data have been submitted (the processor flag bits in the first reading and writing operation conflict detection register have been all reset), the first transaction is submitted.

For example, after the step of determining whether there exists the second transaction that has read the first data or is to read the first data, the example method may further include the following operations.

If the second transaction has conducted the reading operation of the first data, prior to the processing of the first transaction, a cache line of the first data corresponding to the second transaction is copied to a private invisible cache corresponding to the first transaction.

If the second transaction is to conduct the reading operation of the first data, prior to the processing of the second transaction, from a cache line corresponding to the first transaction, the first data to which the writing operation has not been conducted is copied to a cache corresponding to the second transaction.

In order to restore data when a rollback occurs, the transaction is copied prior to the writing operation. In the example embodiment, such characteristic of copying prior to writing is utilized to concurrently read the content which has been copied to improve the overall concurrent degree, reduce the occurrence of conflict, and improve performance.

The following are two examples for illustrating the example embodiment.

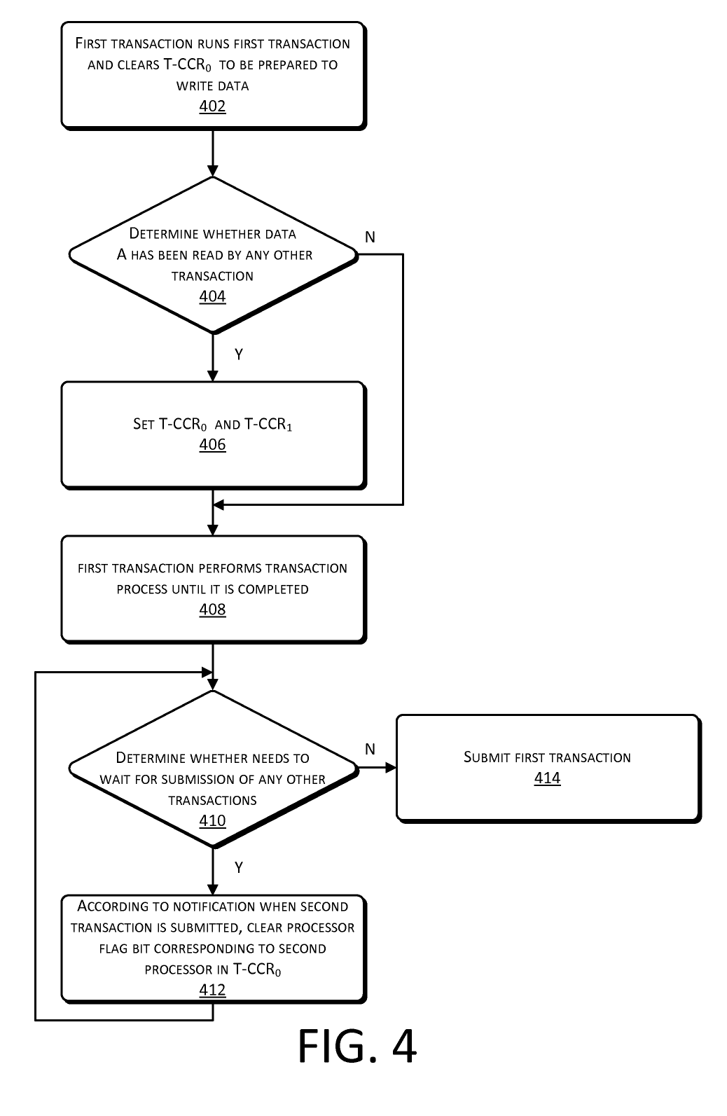

In a first example, a submission is postponed to reduce a reading and writing operation conflict (the data to be written has been read by other transactions), as shown in FIG. 4 that including operations from 402 to 414.

At 402, the first transaction Transaction₀ runs through first processor CPU₀, and the T-CCR₀ of the first processor CPU₀ is cleared to be prepared to write data A

At 404, the present techniques inquire whether the data A has been read by another transaction (whether a read bit of a cache line corresponding to the data A is set). The operations proceed to 408 when the reading operation has not occurred or proceed to 406 when the data A has been read.

At 406, if the data A has been read by the second transaction Transaction₁ (a read bit of a cache line corresponding to the data A has been set), the present techniques set the T-CCR₀ and T-CCR₁. At the T-CCR₁ of the second processor CPU′ that operates the second transaction Transaction₁, the processor flag bit C₀ corresponding to the first processor CPU₀ is set as “1” and the operation flag bit Reader/Writer is set as a value “0” which indicates the occurrence of the reading operation conflict. The cache line is copied to a private invisible cache corresponding to the first transaction Transaction₀ for update. At the T-CCR₀ of the first processor CPU₀ that operates the first transaction Transaction₀, the processor flag bit C₁ corresponding to the second processor CPU₁ is set as “1” and the operation flag bit Reader/Writer is set as a value “1” which indicates the occurrence of the writing operation conflict.

At 408, the first transaction Transaction₀ performs a transaction process until it is completed.

At 410, the present techniques determine whether there needs to wait for submission of any other transactions.

For example, the present techniques may determine whether none of the processor flag bits (C₁˜Cₙ) in T-CCR₀ of the first transaction Transaction₀ is set. If none of the processor flag bits is set, it indicates to perform a normal submission without waiting and operations at 414 are performed.

If at least one of the processor flag bits is set (with value that is not “0”) and the Reader/Writer in T-CCR₀ is “1”, it indicates that the second transaction Transaction₁ is using the data A and therefore there needs to wait for submission of the second transaction Transaction₁. Operations at 412 are performed.

At 412, when the second transaction Transaction₁ is submitted, a transaction operated on a processor corresponding to a processor flag bit having value of “1” in T-CCR₁ is notified (in the example, the present techniques notify the first transaction Transaction₀ since the processor flag bit C₀ is “1”). According to the notification when the second transaction Transaction₁ is submitted, the processor flag bit C₁ corresponding to the second processor in T-CCR₀ is cleared. Operations proceed to 410.

The operations at 412 may be performed prior to the completion of the process done by the first transaction Transaction₀, and thus the first transaction Transaction₀ may be submitted directly without waiting.

At 414, the first transaction Transaction₀ is submitted.

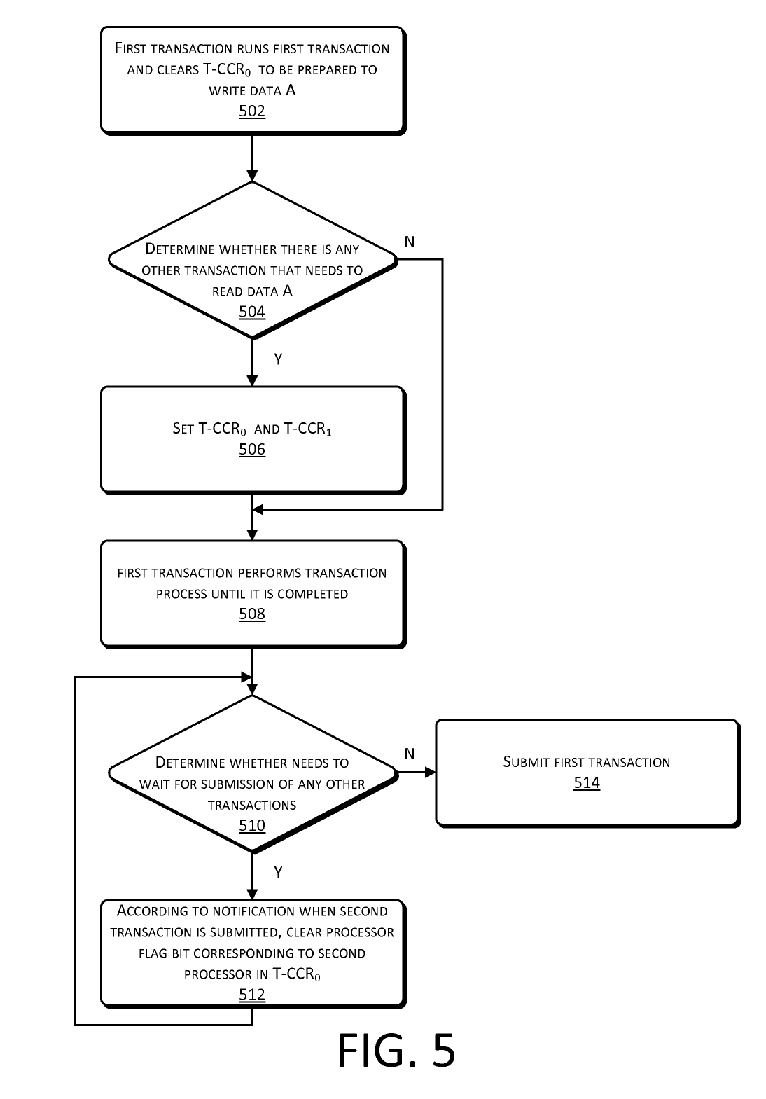

In a second example, a submission is postponed to reduce a writing and reading operation conflict (the data to be written is to be read by other transactions), as shown in FIG. 5 that including operations from 502 to 514.

At 502, the first transaction Transaction₀ runs through first processor CPU₀, and the T-CCR₀ of the first processor CPU₀ is cleared to be prepared to write data A

At 504, the present techniques determine whether there is any other transaction that needs to read the data A. If there is no transaction that needs to read the data A, operations proceed to 508. If there is a second transaction Transaction₁ that needs to read the data A, operations proceed to 506.

At 506, the processor flag bit C₁ corresponding to the second processor CPU₁ at T-CCR₀ is set as “1” and the Reader/Writer is set as “1.” A cache line in the first transaction Transaction₀ corresponding to the original data A (the data A that has not been written) is copied to a cache in the second transaction Transaction₁ (or a private cache). The processor flag bit C₁ corresponding to the second processor CPU₁ at T-CCR₁ is set as “1” and the Reader/Writer is set as “0”.

At 508, the first transaction Transaction₀ performs a transaction process until it is completed.

At 510, the present techniques determine whether there needs to wait for submission of any other transactions.

For example, the present techniques may determine whether none of the processor flag bits (C₁˜Cₙ) in T-CCR₀ of the first transaction Transaction₀ is set. If none of the processor flag bits is set, it indicates to perform a normal submission without waiting and operations at 514 are performed.

If at least one of the processor flag bits is set (with value that is not “0”) and the Reader/Writer in T-CCR₀ is “1”, it indicates that the second transaction Transaction₁ is using the data A and therefore it needs to wait for submission of the second transaction Transaction₁. Operations at 512 are performed.

At 512, when the second transaction Transaction₁ is submitted, a transaction operated on a processor corresponding to a processor flag bit having value of “1” in T-CCR₁ is notified (in the example, the present techniques notify the first transaction Transaction₀ since the processor flag bit C₀ is “1”). According to the notification when the second transaction Transaction₁ is submitted, the processor flag bit C₁ corresponding to the second processor in T-CCR₀ is cleared. Operations proceed to 510.

The operations at 512 may be performed prior to the completion of the process done by the first transaction Transaction₀, and thus the first transaction Transaction₀ may be submitted directly without waiting.

At 514, the first transaction Transaction₀ is submitted.

In the example embodiment, when the first transaction Transaction₀ needs to read data which is written by another transaction, as the Reader/Writer in T-CCR₀ is “1” that indicates that there has been a conflict between the writing operation of the first transaction Transaction₀ and the reading operation of another transaction, the Transaction₀ or the another transaction should be rolled back to prevent a deadlock. (For example, when the another transaction is the second transaction Transaction₁, as a transaction that writes data should wait for a submission of a transaction that reads the data, both the first transaction and the second transaction should have to wait for each other for the submission. Both the first transaction and the second transaction need to wait for submission of each other and accordingly none of the transactions may be submitted.) The processor flag bit in the corresponding T-CCR will be cleared in the rollback operation.

The present disclosure also provides an example device 600 for concurrently accessing memory. The device 600 may include a cache managing unit 602, a first processing unit 604, and a second processing unit 606.

The cache managing unit 602, when a first transaction needs to conduct a writing operation to first data, if there exists a second transaction that have conducted a reading operation of (or have read) the first data or is to conduct a reading operation of the first data, generates a record that indicates a conflict between the writing operation of the first transaction and the reading operation of the second transaction.

The first processing unit 604 performs a processing of the first transaction and, after the processing is completed and a notification of the second transaction is received, submits the first transaction.

The second processing unit 606 performs a processing of the second transaction and, after the process is completed, submits the second transaction and notifies the first transaction according to the record.

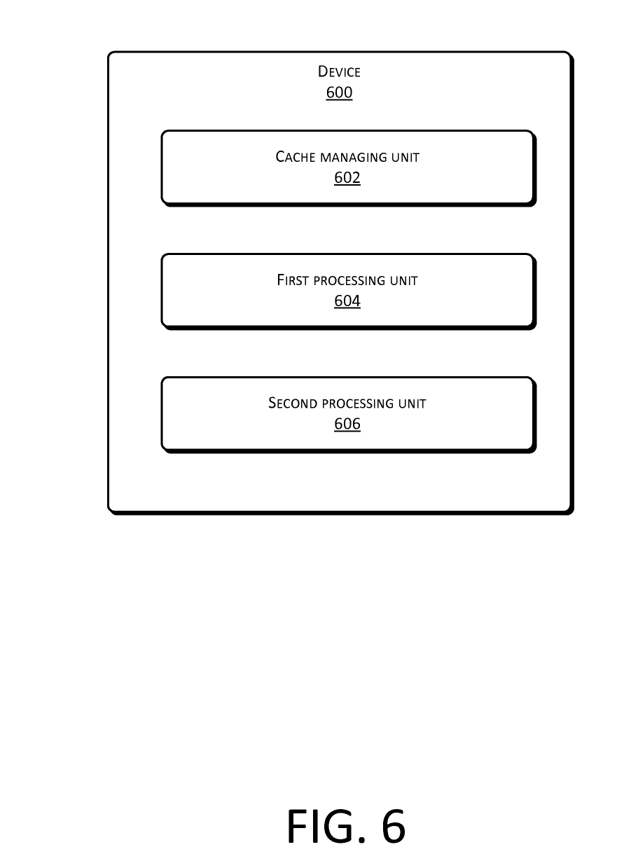

For example, the example device may also include a first reading and writing conflict detection register (not shown in FIG. 6) corresponding to the first processing unit and a second reading and writing conflict detection register (not shown in FIG. 6) corresponding to the second processing unit.

For example, the process that the cache managing unit 602 generates the record indicating the conflict between the writing operation of the first transaction and the reading operation of the second transaction may include the following operations. The cache managing unit 602, at the first reading and writing conflict detection register, sets a processor flag bit corresponding to the second processing unit and sets an operation conflict flag bit as a value indicating an occurrence of a writing operation conflict. The cache managing unit 602, at the second reading and writing conflict detection register, sets a processor flag bit corresponding to the first processing unit and sets the operation conflict flag bit as a value indicating an occurrence of a reading operation conflict.

For example, the process of the second processing unit 606 notifying the first transaction according to the record may include the following operations. The second processing unit 606, at the second reading and writing conflict detection register, searches the processor flag bit that has been set, determines that the processor flag bit that has been set is corresponding to the first processing unit, and notifies the first transaction that is operated on the first processing unit.

For example, the first processing unit 604 may include a first determining module, a second determining module, a performing module, and a cleaning module (all of these modules are not shown in FIG. 6). The performing module performs the process of the first transaction and, after the process is completed, instructing the first determining module to perform a determination.

The clearing module, after the notification of the second transaction is received, at the first reading and writing conflict detection register, resets the processor flag bit corresponding to the second processing unit and instructs the second determining module to perform a determination.

The first determining module determines whether the operation conflict flag bit in the first reading and writing conflict detection register is the value indicating the occurrence of the writing operation conflict. If a determination result is positive, the first determining module instructs the second determining module for determination. If the value indicates the occurrence of the reading operation conflict, the first determining module instructs a submitting module to submit the first transaction.

The second determining module determines whether none of the processor flag bits at the first reading and writing conflict detection register is set. If a determination result is positive, the second determining module instructs the submitting module to submit the first transaction.

For example, the cache managing unit 602, when it is determined that the second transaction has read the first data, before the first processing unit performs the first transaction, copies a cache line of the first data corresponding to the second transaction to a private invisible cache corresponding to the first transaction.

If the cache managing unit 602 determines that the second transaction is to read the first data, before the second processing unit performs the processing of the second transaction, from a cache line corresponding to the first transaction, copies the first data to which the writing operation has not been conducted to a cache corresponding to the second transaction.

One of ordinary skill in the art would understand that all or partial of the steps or operations in the method of the present disclosure be implemented by related hardware instructed by program instructions or computer-executable instructions. The program instructions may be stored in a computer readable storage medium, such as a read-only memory, a magnetic disk or optical disk, etc. Alternatively, all or partial of the steps or operations in the embodiments of the present disclosure may be implemented by one or more integrated circuits. Accordingly, all of the modules/units in the embodiments of the present disclosure may be implemented in the form of hardware or software function modules. The present disclosure is not limited to any specific combination of hardware and software.

It is noted that the present disclosure may have various embodiments. One of ordinary skill in the art may make various modifications and variations according to the present disclosure without departing from the spirit and essence of the present disclosure. Such modifications and variations should fall within the protection scope of the present disclosure and its claims.

What is claimed is:

1. A method comprising:
generating a record that indicates a conflict between the writing operation of a first transaction and the reading operation of a second transaction when the first transaction needs to conduct a writing operation to first data, after determining that the second transaction has conducted a reading operation of the first data or is to conduct the reading operation of the first data;
performing a processing of the second transaction, and, after the processing of the second transaction is completed, submitting the second transaction and notifying the first transaction according to the record; and
performing a processing of the first transaction, and, after the processing of the first transaction is completed and a notification of the second transaction is received, submitting the first transaction.

2. The method of claim 1, wherein the generating the record that indicates the conflict between the writing operation of the first transaction and the reading operation of the second transaction comprises:
setting a processor flag bit corresponding to a second processor which operates the second transaction and setting an operation conflict flag bit of the first reading and writing conflict detection register as a value indicating an occurrence of the writing operation conflict at a first reading and writing conflict detection register of a first processor that operates the first transaction; and
setting a processor flag bit corresponding to the first processor and setting an operation conflict flag bit of the second reading and writing conflict detection register as a value indicating an occurrence of the reading operation conflict at a second reading and writing conflict detection register of the second processor.

3. The method of claim 2, wherein the notifying the first transaction according to the record comprises:
searching the processor flag bit that has been set at the second reading and writing conflict detection register;
determining that the processor flag bit that has been set corresponds to the first processor; and
notifying the first transaction that is operated at the first processor.

4. The method of claim 2, wherein the performing the processing of the first transaction, and, after the processing of the first transaction is completed and the notification of the second transaction is received, submitting the first transaction comprises:
at a step A, performing the processing of the first transaction and, after the processing of the first transaction is completed, performing a step B;
at the step B, determining whether the operation conflict flag bit of the first reading and writing conflict detection register is set as the value indicating the occurrence of the writing operation conflict,
if a determining result is positive, performing a step C; or
if the operation conflict flag bit is set as the value indicating the occurrence of the reading operation conflict, performing a step E;
at the step C, determining whether none of the processor flag bits of the first reading and writing conflict detection register is set,
if at least one of the processor flag bits has been set, coming to a standby state; or
if none of the processor flag bits is set, performing the step E;
at a step D, after the notification of the second transaction is received, at the first reading and writing conflict detection register, resetting the processor flag bit corresponding to the second processor and returning to the step C; and
at the step E, submitting the first transaction.

5. The method of claim 1, wherein the method, after determining that there exists a second transaction that has conducted a reading operation of the first data or is to conduct the reading operation of the first data, further comprises:
copying a cache line of the first data corresponding to the second transaction to a private invisible cache corresponding to the first transaction if the second transaction has conducted the reading operation of the first data, prior to the processing of the first transaction; or
copying the first data to which the writing operation has not been conducted to a cache corresponding to the second transaction if the second transaction is to conduct the reading operation of the first data, prior to the processing of the second transaction, from a cache line corresponding to the first transaction.

6. A device comprising:
a cache managing unit that, when a first transaction needs to conduct a writing operation to first data, when there exists a second transaction that has conducted a reading operation of the first data or is to conduct the reading operation of the first data, generates a record that indicates a conflict between the writing operation of the first transaction and the reading operation of the second transaction;
a first processing unit that performs a processing of the first transaction, and, after the processing of the first transaction is completed and a notification of the second transaction is received, submits the first transaction; and
a second processing unit that performs a processing of the second transaction, and, after the processing of the second transaction is completed, submits the second transaction and notifies the first transaction according to the record.

7. The device of claim 6, further comprising:
a first reading and writing conflict detection register that corresponds to the first processing unit; and
a second reading and writing conflict detection register that corresponds to the second processing unit.

8. The device of claim 7, wherein the cache managing unit further:
at the first reading and writing conflict detection register, sets a processor flag bit corresponding to the second processing unit and sets an operation conflict flag bit of the first reading and writing conflict detection register as a value indicating an occurrence of the writing operation conflict.

9. The device of claim 7, wherein the cache managing unit further:
at the second reading and writing conflict detection register, sets a processor flag bit corresponding to the first processing unit and sets an operation conflict flag bit of the second reading and writing conflict detection register as a value indicating an occurrence of the reading operation conflict.

10. The device of claim 7, wherein the second processing unit further:
at the second reading and writing conflict detection register, searches the processor flag bit that has been set;
determines that the processor flag bit that has been set corresponds to the first processing unit; and
notifying the first transaction that is operated at the first processing unit.

11. The device of claim 7, wherein the first processing unit comprises:
a first determining module;
a second determining module;
a performing module that performs the processing of the first transaction and, after the processing of the first transaction is completed, instructs the first determining module to make determination; and
a clearing module that, after the notification of the second transaction is received, at the first reading and writing conflict detection register, resets the processor flag bit corresponding to the second processing unit and instructs the second determining module to make determination,
wherein:
the first determining module determines whether the operation conflict flag bit of the first reading and writing conflict detection register is set as the value indicating the occurrence of the writing operation conflict,
if a determining result is positive, instructs the second determining module to make determination; or
if the operation conflict flag bit is set as the value indicating the occurrence of the reading operation conflict, instructs a submitting module to submit the first transaction; and
the second determining module determines whether none of the processor flag bits of the first reading and writing conflict detection register is set, and in response to determining that none of the processor flag bits is set, instructs the submitting module to submit the first transaction.

12. The device of claim 6, wherein the cache managing unit further copies a cache line of the first data corresponding to the second transaction to a private invisible cache corresponding to the first transaction when the second transaction has conducted the reading operation of the first data, prior to the processing of the first transaction.

13. The device of claim 6, wherein the cache managing unit further copies the first data to which the writing operation has not been conducted to a cache corresponding to the second transaction when the second transaction is to conduct the reading operation of the first data, prior to the processing of the second transaction, from a cache line corresponding to the first transaction.

14. One or more memories stored thereon computer-executable instructions executable by one or more processors to perform operations comprising:
when a first transaction needs to conduct a writing operation to first data, after determining that there exists a second transaction that has conducted a reading operation of the first data or is to conduct the reading operation of the first data, generating a record that indicates a conflict between the writing operation of the first transaction and the reading operation of the second transaction;
performing a processing of the second transaction, and, after the processing of the second transaction is completed, submitting the second transaction and notifying the first transaction according to the record; and
performing a processing of the first transaction, and, after the processing of the first transaction is completed and a notification of the second transaction is received, submitting the first transaction.

15. The one or more memories of claim 14, wherein the generating the record that indicates the conflict between the writing operation of the first transaction and the reading operation of the second transaction comprises:
at a first reading and writing conflict detection register of a first processor that operates the first transaction, setting a processor flag bit corresponding to a second processor which operates the second transaction and setting an operation conflict flag bit of the first reading and writing conflict detection register as a value indicating an occurrence of the writing operation conflict.

16. The one or more memories of claim 14, wherein the generating the record that indicates the conflict between the writing operation of the first transaction and the reading operation of the second transaction comprises:
at a second reading and writing conflict detection register of the second processor, setting a processor flag bit corresponding to the first processor and setting an operation conflict flag bit of the second reading and writing conflict detection register as a value indicating an occurrence of the reading operation conflict.

17. The one or more memories method of claim 16, wherein the notifying the first transaction according to the record comprises:
at the second reading and writing conflict detection register, searching the processor flag bit that has been set;
determining that the processor flag bit that has been set corresponds to the first processor; and
notifying the first transaction that is operated at the first processor.

18. The one or more memories of claim 15, wherein the performing the processing of the first transaction, and, after the processing of the first transaction is completed and the notification of the second transaction is received, submitting the first transaction comprises:
at a step A, performing the processing of the first transaction and, after the processing of the first transaction is completed, performing a step B;
at the step B, determining whether the operation conflict flag bit of the first reading and writing conflict detection register is set as the value indicating the occurrence of the writing operation conflict,
if a determining result is positive, performing a step C; or
if the operation conflict flag bit is set as the value indicating the occurrence of the reading operation conflict, performing a step E;
at the step C, determining whether none of the processor flag bits of the first reading and writing conflict detection register is set,
if at least one of the processor flag bits has been set, coming to a standby state; or
if none of the processor flag bits is set, performing the step E;
at a step D, after the notification of the second transaction is received, at the first reading and writing conflict detection register, resetting the processor flag bit corresponding to the second processor and returning to the step C; and
at the step E, submitting the first transaction.

19. The one or more memories method of claim 14, wherein the operations, after determining that there exists a second transaction that has conducted a reading operation of the first data or is to conduct the reading operation of the first data, further comprise:
if the second transaction has conducted the reading operation of the first data, prior to the processing of the first transaction, copying a cache line of the first data corresponding to the second transaction to a private invisible cache corresponding to the first transaction.

20. The one or more memories method of claim 14, wherein the operations, after determining that there exists a second transaction that has conducted a reading operation of the first data or is to conduct the reading operation of the first data, further comprise:
If the second transaction is to conduct the reading operation of the first data, prior to the processing of the second transaction, from a cache line corresponding to the first transaction, copying the first data to which the writing operation has not been conducted to a cache corresponding to the second transaction.
